(19) United States
(12) Patent Application Publication
(10) Pub. No.: US 2017/0248836 A1
(43) Pub. Date: Aug. 31, 2017

(54) MINIATURE CAMERA

(71) Applicant: Ralph STERCHI, Bern (CH)

(72) Inventor: Ralph STERCHI, Bern (CH)

(21) Appl. No.: 15/329,950

(22) PCT Filed: Jul. 7, 2015
(86) PCT No.: PCT/CH2015/000100

§ 371 Date: Jan. 27, 2017

(30) Foreign Application Priority Data
Jul. 28, 2014 (CH) 1152/14

(51) Int. Cl. G03B 17/56; F16M 11/12; A45F 5/02; F16M 11/18; H04N 5/232; F16M 11/22; H04N 5/225; F16M 13/04

(52) U.S. Cl. CPC G03B 17/561; H04N 5/2252; F16M 11/12; F16M 13/04; F16M 11/18; H04N 5/23258; F16M 11/22; A45F 5/02; F16M 2200/041; A45F 2200/0533

(57) ABSTRACT

A device (1) for fastening to a garment comprises a housing (10), an image recording unit (100) having an optical axis (110) and being connected to the housing (10), and a fastening device (300) for fastening the housing (10) to the garment. The housing (10) has a contact surface (12) for contact with the garment such that the optical axis (110) of the image recording unit (100) can be swiveled perpendicularly or is permanently swiveled perpendicularly to the contact surface (12).

### TECHNICAL FIELD

The invention relates to a device for fastening to a garment, comprising a housing, an image recording unit having an optical axis and being connected to the housing, and a fastening device for fastening the housing to the garment, the housing having a bearing surface for bearing on the garment.

### PRIOR ART

Many types of small cameras are already known from the prior art. For example, cameras under the brand name GoPro are known which can be fastened in a variety of ways to objects and also to a person via an exchangeable holder. In addition to clamps, strap systems are also known with which a person is able to wear the camera.

However, the known camera systems have the disadvantage that, despite the very wide variety of fastening devices for fastening to garments, they cannot be used sufficiently flexibly.

### DISCLOSURE OF THE INVENTION

The object of the invention is to make available an image recording device which belongs to the technical field mentioned at the outset and which can be oriented in an optimal manner when fastened to a garment.

The object is achieved by the features of claim 1. According to the invention, the optical axis of the image recording unit is tiltable or permanently tilted with respect to the perpendicular to the bearing surface.

The term “optical axis” is understood below as meaning a connecting line between two midpoints of two parallel image planes spaced apart from each other. To put it another way, it is a straight line which impinges centrally through the optics in the middle of the image sensor.

The image recording unit preferably comprises at least one image sensor for detecting image data. In addition, the image recording unit can also comprise optical elements such as lenses or filters. The image recording unit is provided for recording images or films or both.

The image recording unit is preferably tiltable or permanently tilted at least partially within the housing. Thus, the bearing surface of the housing can also better take up shifts in the center of gravity of the image recording unit, which can occur as a result of a pivoting movement of the image recording unit depending on the construction. Moreover, the image recording unit is better protected, and the device can be made more compact. The housing thus preferably forms a unit together with the bearing surface, or the bearing surface is preferably in a fixed orientation relative to the housing.

Alternatively, the image recording unit can also be connected to the housing outside the housing.

The bearing surface of the housing is understood as a preferably plane area located around the fastening device. The housing typically has an at least substantially prismatic shape, wherein the image recording unit is arranged on or in a top surface, and the second top surface, which in this case serves as bearing surface, comprises the fastening device. It is clear, however, that the bearing surface does not strictly speaking have to be flat. For example, the bearing surface can have a structure which can prevent the device from slipping on the garment. This structure can, for example, comprise knobs, in particular rubberized knobs with a high friction resistance. If the fastening device is provided as a hook-and-loop fastener for example, the bearing surface of the device will have a corresponding structure (see below in this regard).

The garment to which the device can be fastened via the fastening device can likewise be of basically any desired kind. However, it is typically a textile garment, in which case the fastening device can comprise a needle, for example. The textile garment is preferably in the form of an item of clothing of the upper body and can be designed, for example, as a jacket, pullover, shirt, coat or the like. Alternatively, however, other garments such as trousers, a cap, hat, shawl, belt and the like can also be provided for fastening the device.

The aim of a camera fastened to a garment is to be able to capture a defined field with the imaging. However, when fastened to a garment, a camera adopts an orientation corresponding to the orientation of the bearing surface of the garment. In the case of a camera that has an optical axis oriented at right angles to the bearing surface of the camera, the optical axis would be oriented obliquely upward, for example when the fastening is in the area of the shoulder, whereas the optical axis is oriented more horizontally when the fastening is on a collar of a jacket, for example. The orientation of the optical axis thus depends on the location of the fastening to the garment and, if appropriate, on the garment itself.

By virtue of the fact that the optical axis of the device according to the invention is not oriented in the usual way at right angles to the bearing surface, there is now the possibility whereby a camera that is fastenable to a garment can be designed in such a way that the optical axis is oriented optimally with respect to the bearing surface.

According to the invention, this is achieved by the fact that the optical axis is not at right angles to the bearing surface but instead inclined. Thus, for example, a device according to the invention can be designed in such a way that, when the fastening is in the shoulder area, the inclination of the bearing on the shoulder is compensated.

In the case of a permanently tilted camera, the orientation of the optical axis can be influenced within a smaller range. If the optical axis of the device fastened to the garment is not oriented horizontally as desired, the device may be offset upward or downward in the area of curvature of the shoulder. In particular, the permanently tilted camera can also be optimized, in terms of the field of view, by the use of a wide-angle optical system.

In a preferred embodiment, the optical axis is itself tiltable with respect to the bearing surface. In this embodiment, the optical axis can also be re-oriented after being fastened to a garment or can also only be adjusted. This is advantageous especially when the person wearing the camera is, for example, sitting on a seat with the backrest tilted back, such that the optical axis with the correct orientation when the person is standing is now oriented obliquely upward and the target of the person wearing the camera is no longer detected. In this case, the person wearing the camera does not have to carefully remove the device from the garment and then fasten it again. Instead, all that he has to do is to suitably incline the optical axis with respect to the bearing surface of the device. However, this advantage is afforded not only when changing the position or the orientation of the garment comprising the device, but also when the person wearing the camera decides to change the target of the camera. By way of example, when recording a person standing opposite, the person wearing the camera can easily adapt the orientation of the optical axis to the height of this person standing opposite.

Preferably, the image recording unit is tiltable relative to the housing such that an angle of the optical axis with respect to the bearing surface changes. Particularly preferably, the image recording unit is tiltable at least partially inside the housing.

In variants, the image recording unit can also be mounted, alternatively or additionally, so as to be rotatable about the optical axis relative to the housing.

Preferably, the image recording unit is tiltable about at least one rotation axis, wherein the rotation axis is particularly preferably oriented parallel to the bearing surface. An individual rotation axis can thus be oriented, for example, horizontally with respect to the fastening, such that the optical axis is tiltable in a vertical plane.

However, the image recording unit can also be tiltable about more than one pivot axis. In the case of two pivot axes, these are preferably arranged at right angles to each other. For example, one of the pivot axes can be oriented parallel to the bearing surface and the other at right angles to the bearing surface, wherein the image recording unit is tiltable relative to the parallel pivot axis and the latter in turn is pivotable about the right-angled pivot axis.

Alternatively, the device can have a bearing surface that is tiltable about at least one axis. This would have the advantage that the image recording unit can be moved as a whole together with electronics, power supply, switches, etc., and the device can thus have a robust, cost-effective and simple structure. A disadvantage would be that a greater mass would thus possibly have to be fixed in one orientation, as a result of which the orientation of the optical axis may become difficult in some circumstances.

Preferably, the image recording unit is mounted in or on the housing via a ball guide, such that the image recording unit is tiltable along a spherical cap. The ball guide has the advantage that the image recording unit can be oriented in substantially any desired manner. Preferably, the image recording unit has a ball shape in the mounted area. The shape is typically a sphere segment, the objective of the image recording unit being arranged in the area of the sectional surface. The sphere segment can have a structured outer envelope, whereby a friction resistance with respect to the bearing of the ball segment can be adjusted in such a way that the image recording unit can be oriented by hand but does not spontaneously move in the event of vibrations or accelerations. To this end, it is advantageous if the center of gravity of the image recording unit with the spherical segment-shaped envelope lies in the ball center.

In variants, it is also possible to provide separate axes via which the image recording unit is tiltable.

Preferably, the image recording unit comprises a protruding, preferably rectangular frame, on which an orientation of the image recording unit can be set and adjusted by hand. In this way, it is firstly possible to detect by hand the direction in which the optical axis of the image recording unit is oriented. Secondly, the image recording unit can be easily gripped and newly oriented or adjusted via the frame. The rectangular shape is advantageous since any rotation about the optical axis can thus also be ascertained (apart from a 180° rotation about the optical axis). Moreover, the image format can be imitated in this way, as a result of which the orientation of the camera is more intuitive. Moreover, the frame forms an abutment or movement limiter for the tilt of the optical axis. In principle, however, the frame could also have a square shape, thus making it possible to ascertain a rotation in the range of 90°. The frame can optionally be round if a rotation about the optical axis is not intended. Other possible shapes of the frame are also known to a person skilled in the art.

In variants, the frame can also be omitted. In this case, for example, an automated orientation of the image recording unit or of the optical axis can be provided.

For such an embodiment, the ball guide can preferably be actuated by means of a motor drive, in particular by means of a gearwheel drive. The orientation of the optical axis can thus take place automatically, without the wearer having to actively intervene. The orientation can be effected by known means, for example a pattern recognition. Thus, for example, a defined target in space can be programmed into the image recording unit, to which target the optical axis, as far as possible, is then automatically kept oriented, e.g. by image recognition or by space vectors. The respective corrections could in this case be effected by motor. Moreover, the device can also be designed in such a way that the image recording unit in each case adopts a constant orientation in spatial terms, for example horizontally, since only the inclination of the optical axis with respect to the horizontal is compensated by motor.

In the particularly preferred embodiment, the rotation impulse is transmitted to the spherical housing of the camera by gearwheel. With the teeth of the gearwheel, the gearwheel can set the housing in rotation by static friction. Moreover, the gearwheel can be positioned in such a way that the housing lies between two teeth and is therefore not in engagement with the gearwheel. In this configuration, the housing can be freely rotated, for example by hand or via another motor drive. Preferably, the device comprises at least one further gearwheel, which is able to rotate the housing about a further rotation axis, particularly if the first gearwheel or the further gearwheels are not in engagement with the housing.

Alternatively, it is also possible to dispense with the motor drive. It is possible either to do completely without an automatic orientation of the optical axis or to achieve this by other means. In the latter case, for example, an orientation can be achieved via magnets or piezo elements, wherein for example only individual positions can be adopted. For example, with 4 or 6 different orientations, a viewing field of 180° or more can thus be covered depending on the image angle. Further actuators are also known to a person skilled in the art and can be used as drives for the automatic orientation of the optical axis, for example via thermally controlled bimetals or the like. Finally, an automatic orientation of the optical axis can also be achieved via a tiltable mirror, such that the image recording unit can be fixed relative to the bearing surface.

Preferably, the device comprises a gravitation sensor, wherein the automatic drive, in particular the motor drive, is in data communication with the gravitation sensor. The orientation of the image recording unit can thus be controlled via the gravitation sensor in such a way that the optical axis is in each case oriented horizontally, for example, or adopts a defined angle to the horizontal. Moreover, the device can comprise an electronic compass which is likewise in data communication with the automatic drive. Particularly preferably, the device comprises both the compass and the gravitation sensor, such that an orientation is possible both horizontally and also vertically. Such sensors and compasses are known to a person skilled in the art and are already used in many electronic appliances, for example cell phones or tablets.

In variants, it is also possible to dispense with the gravitation sensor or the compass. Instead, the device can also have a receiver for other data, on the basis of which the automatic drive can be controlled. Such a receiver can receive at any known frequencies, for example radio, Bluetooth, infrared and the like.

Preferably, the fastening device comprises a foldable part which is designed as a clamp when oriented parallel to the bearing surface and which is designed as a stand when inclined with respect to the bearing surface. In this way, two functions can be achieved in a particularly simple manner in terms of construction. In a preferred embodiment, this fastening device comprises a plate-shaped part which is connected to the housing via a joint, for example a hinge or a flexible element. The part can be held in the parallel position, for example via magnets, and thus provide the clamping action. To ensure that the part is kept stable in the inclined state, a latching device can be provided, for example, or a chosen friction resistance of the hinge can be sufficiently great.

In a further embodiment, the device can have an above-described clamp, wherein the plate-shaped part comprises holding devices with which the the device can be fastened to a garment. In this way, the tilt of the camera can be obtained through the tiltable plate-shape part, as a result of which a particularly simple set-up of the device is achieved.

In variants, it is also possible to dispense with the design of the fastening device as a stand. In this case, the fastening device takes on only the function of the fastening to a garment.

Preferably, the fastening device comprises at least one needle, preferably three needles, and can be connected to the housing particularly in a releasable manner. The needles can be designed in principle in a known manner as safety needles or the like, although they can also be in the form described further below. The needle can preferably be latched in order to lock it. It is thus possible to ensure in the closed position that the needle does not transfer uncontrollably to the open position. In addition, a lock for the open position can be provided, as a result of which a danger of injury can be reduced. Alternatively, it is also possible to dispense with the latching.

Preferably, the fastening device comprises three needles, such that the device, in the fastened state, is as far as possible unable to move relative to the garment. The precision and the robustness of the orientation of the optical axis can thus be increased. The fastening device and the needles are preferably oriented parallel to each other. In a particularly preferred embodiment, two are arranged horizontally at the same height in an upper area of the housing, and one is arranged in a lower area of the housing, as a result of which the three fastening devices form, for example, the corners of an isosceles triangle. Particularly robust fastening of the device to a garment is achieved in this way. The fastening device can of course also comprise one, two or more than three needles, which in particular can also be positioned in any desired manner.

In variants, the fastening device can also comprise no needle. For example, the fastening device, as has already been described, can have a clamping mechanism. The clamping mechanism can comprise a spring-loaded element which clamps the garment between the housing of the device and the element. However, the clamping mechanism can also be designed like scissors or tongs, such that the garment is clamped between two parts of the clamping device. Moreover, the fastening device can also comprise a hook-and-loop fastener or a button for a buttonhole of a garment. Other suitable fastening devices are also known to a person skilled in the art.

In a preferred embodiment, the fastening device can be connected releasably to the housing. This has the advantage that a defective fastening device can be replaced effortlessly. The fastening can be effected, for example, by screwing, by a clip connection or a latch connection or the like. A further advantage is that the fastening device can also be used independently of the device. For example, the fastening device can also be used for name badges or the like. Moreover, the fastening device can be used, for example, for microphones, brooches, etc. Other possible uses in this regard are known to a person skilled in the art.

Preferably, the needle is designed as an arc-shaped needle which is guided in an arc-shaped guide, wherein the arc-shaped guide comprises at least one outlet opening in the bearing surface or in a surface adjoining the bearing surface. A fastening device is thus made available that is particularly easy to handle in ergonomic terms and that has a needle. Particularly by comparison with the known safety needles, this embodiment affords the advantage that the movement required for the operation is positively guided, i.e. it does away with the effort involved in aiming the needle tip into the receiving pocket of a conventional safety needle.

A further advantage lies in the fact that the piercing of the garment is made easier, since the arc shape of the needle, similar to that of surgical needles, follows a curved path, as a result of which the garment is as it were picked up by the needle. If the layer thickness of the garment at the location where the device is intended to be fastened is greater than the arc height that the part of the needle emerging from the guide is able to adopt, the fastening device can simply be laid onto the garment and the needle moved along the arc trajectory, as a result of which the needle automatically penetrates the garment without any danger of injury to the person wearing the device. Otherwise, the garment, in the area peripheral to the insertion site, can also be easily lifted slightly away from the body in order to guide the needle safely along the arc trajectory through the garment.

In a first variant, the fastening device comprises a receiving opening into which the needle can be guided after it has passed through the garment. In this way, the needle tip is protected and the fastening is made more robust. To this end, the guide can be designed as a continuous arc-shaped opening with outlet opening and inlet opening, wherein the needle for fastening to a garment emerges at the outlet opening and enters the inlet opening.

In a second variant, the fastening device comprises a second arc-shaped guide, which is arranged concentrically with respect to the first one. In this way, two needles can be moved toward each other in such a way that their tips meet at a point and either pass through a garment (sharp needle) or clamp a garment (blunt needle). In this case, the needle can be acted upon by a spring force which holds the needle in the closed position. Moreover, a latching device can be provided which holds the fastening device in the closed position.

In variants, the needle can also be configured in different ways. For example, the fastening device can have a recess into which the garment is inserted, said recess being bridged by a needle that is movable in a straight line.

Preferably, the needle is connected to an actuation element which is preferably oriented in a plane with a normal vector parallel to the tangent, wherein the guide comprises a slit for the passage of the actuation element. Particularly preferably, the actuation element additionally lies parallel to the plane of the guide trajectory or at right angles thereto.

In variants, the actuation element can also be oriented tangentially. In this case, the actuation element can also be connected pivotably to the needle and can be designed as an elongate pin, such that the actuation can also take place at a distance from the needle.

Preferably, the arc-shaped guide is oriented at right angles to the bearing surface, such that the device only has to be pressed with slight pressure onto the garment, such that the arc-shaped needle penetrates the garment when the fastening device is actuated.

In variants, the guide can also be oriented parallel to the bearing surface, in which case, for successful actuation of the fastening device, care has to be taken to ensure that part of the garment is gripped by the needle through the actuation of the fastening device.

Preferably, in addition to the image recording unit, the device also comprises a microphone, such that sound recordings are also permitted in addition to the image recordings. The device can also comprise further sensors, for example a motion sensor, an infrared camera and the like. With these sensors, for example, the image recording unit can be controlled such that the image recording unit is activated in response to a movement, a sound, or a change in a thermal image. Moreover, if the image recording unit is automatically tiltable, the one or more actuators can also be accordingly controlled. This has the advantage that image recordings can be performed only when when there is a change in the surroundings ahead or when something happens. If appropriate, in addition to saving storage space, power consumption can also be optimized in this way, provided that the sensor controlling the image recording unit uses less power than the image recording unit.

In variants, the microphone can also be omitted.

Preferably, the device comprises at least one operating element, in a particular a knob, or a status display, preferably an LED, or both.

Various functions can be controlled with the operating element. For example, a recording sequence can be started, changed or ended using the operating element. A rotary switch can be provided in order to switch between recording phases A, B, C, etc., such that the video recording can be divided manually into sequences or recording phases. Moreover, one or more operating elements can also be used to set further parameters that are known to a person skilled in the art in connection with the recording of videos or images, for example exposure, aperture, etc., but also parameters of other functions, for example of a microphone and the like.

In a particularly preferred embodiment, the camera is used for long-term recording, and therefore the lowest possible power consumption is sought. In order to optimize the device in this sense, various measures can be taken:
The device can be equipped with a current generator, for example with solar cells, with an automatic timer coupled to a current generator, and further means known to a person skilled in the art.
The device can additionally be designed such that as little power as possible is consumed. For this purpose, mechanical circuits can be provided, for example a rotary switch or a slide switch. This has the advantage that a switching state can likewise be presented without power, since the state can be identified from the switch position.
The image frequency in video recordings can be reduced, particularly in recordings of rather slow movements. If appropriate, the image frequency can be controlled via a motion sensor or via an image evaluation unit.

Further measures by which a current consumption of such a device can be kept low are also known to a person skilled in the art.

Preferably, the device comprises a status display which, for example, indicates an operating mode or the charging state of the battery. The status display for the battery state is preferably designed as an LED, which preferably indicates exactly two states, namely “Battery charged” and “Battery uncharged”. Preferably, the LED lights when the battery is full, such that it is possible to ascertain at all times whether the device is ready to operate.

In variants, it is also possible to dispense with the operating element. Either a corresponding function can be omitted, or the function can be automated, for example via sensors.

Preferably, the device comprises a data processor which is connected to the image recording unit via a connector, wherein the connector has first and second contact faces which are oriented parallel to each other and are in sliding contact, wherein at least one of the contact faces is movable with respect to the second contact face in the plane of the contact face. In this way, movements between image recording unit and housing can be recorded. This design additionally has the advantage that no resistance force or a constant resistance force counteracts the movement, such that, when the optical axis is adjusted, the desired position can be fixed. By contrast, the use of simple connection cables or ribbon cables has the disadvantage that, on account of a certain spring action, the image recording unit cannot be held stable in one position, except if the static friction chosen between image recording unit and housing is sufficiently great.

Alternatively or additionally, the connector can also be used to transmit power. In variants, however, it is also possible to omit the connector. In this case, the freedom of movement of the image recording unit in relation to the housing can also be achieved through longer and flexible cables.

Preferably, the first contact face is rotatable with respect to the second contact face about a rotation axis, and one of the contact faces preferably has a ring conductor which is coaxial to the rotation axis and which is directed toward the other contact face and is in sliding contact, in particular for data transmission and power supply.

In a particularly preferred embodiment, at least one of the contact faces has a disk shape. In this way, rotation movements between housing and image recording unit can be recorded. The ring conductor ensures the contact for the power or data transmission between the two contact faces. Each data line or power line corresponds with a ring conductor of a defined diameter.

In variants, other relative movement directions can also be effected by the two contact faces. One contact face can, for example, be guided linearly or along a curved guide in relation to the second contact face. In a further variant, the contact face can also have the shape of a cylinder/piston. For this purpose, the piston, for example, comprises contact faces extending around the outside and spaced apart in the longitudinal direction, while the cylinder comprises contact elements that are positioned corresponding to the contact faces. Alternatively, it is also possible for the cylinder to comprise the contact faces and for the piston to comprise the contact elements. The contact faces and contact elements can be designed as the known sliding contact.

Further advantageous embodiments and combinations of features of the invention will become clear from the following detailed description and from the entirety of the claims.

### BRIEF DESCRIPTION OF THE DRAWINGS

In the drawings used to explain the illustrative embodiment:

FIG. 1 shows a schematic sectional representation along the optical axis of a first embodiment of an image recording unit;

FIG. 2 shows a plan view, in the direction of the optical axis, of a schematic representation of a second embodiment of an image recording unit;

FIG. 3 shows a schematic representation of the function of a gearwheel drive for the automatic orientation of the optical axis;

FIG. 4 shows a front view of an embodiment of the device comprising an image recording unit;

FIG. 5 shows a rear view of the device according to FIG. 4;

FIG. 6a shows a sectional representation, along the optical axis, through the fastening device located in the open state;

FIG. 6b shows a representation according to FIG. 6a in the closed state;

FIG. 6c shows a sectional representation, along the optical axis, through the fastening device located in the open state and designed as an exchangeable unit;

FIG. 7 shows a schematic sectional representation of a connector;

FIG. 8 shows a schematic representation of a connector plate along the rotation axis.

In the figures, identical parts are in principle provided with identical reference signs.

### WAYS OF IMPLEMENTING THE INVENTION

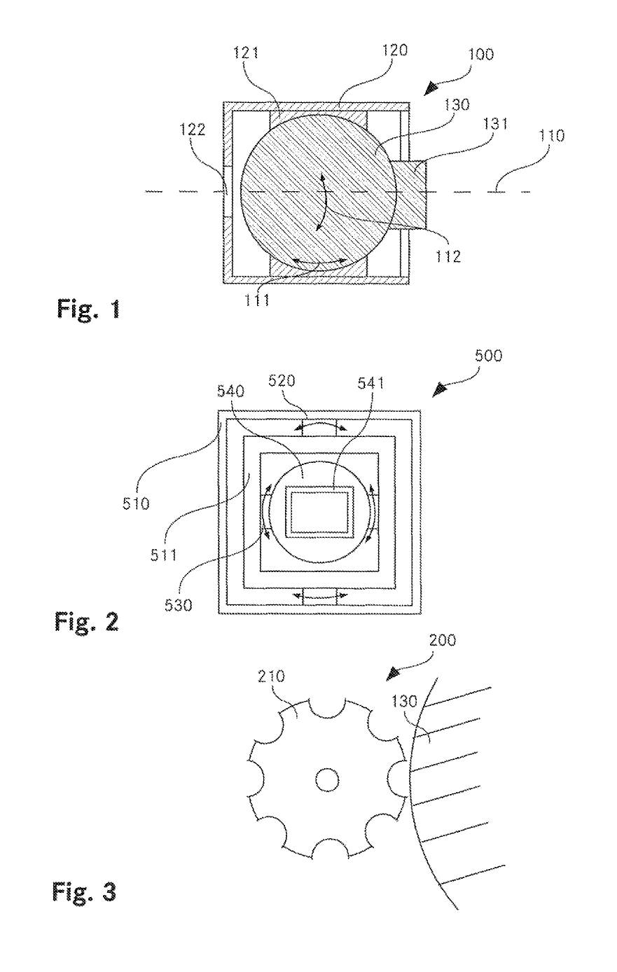

FIG. 1 shows a schematic sectional representation along the optical axis 110 of a first embodiment of an image recording unit 100. The image recording unit comprises a cuboid outer housing 120 with a rear wall and four side walls and is open to the front. A camera mount 121 for receiving the camera 130 is formed inside the housing 120 and is connected rigidly to the housing 120. The camera 130 is ball-shaped and comprises a projection 131 which borders the objective and by which the camera 130 can be gripped and adjusted. The projection 131 additionally forms an abutment for the camera 130 to the housing 120. The camera 130 is thus tiltable about the ball bearing in all directions, as is indicated by the arrows 111 and 112. Moreover, the camera 130 can also be rotated about the optical axis 110. In the rear wall, the housing has an opening 122 for the passage of data cables and power supply cables. In the present embodiment, the housing 120 protrudes beyond the camera mount 121 in the direction of the optical axis 110. However, it will be clear to a person skilled in the art that the housing 120 does not necessarily have to protrude beyond the camera mount 121, or not to the extent shown.

While the present embodiment is configured for manual setting of the optical axis 110, another embodiment may also be provided with a motor drive. The latter can, for example, comprise a stepping motor for each rotation axis (see FIG. 3 in this regard).

FIG. 2 shows a plan view, in the direction of the optical axis, of a schematic representation of a second embodiment of an image recording unit 500. This image recording unit 500 comprises a first cuboid housing 510, and a second cuboid housing 511 which is mounted inside the first housing 510 about a first rotation axis 520. The second housing 511 has external dimensions smaller than the internal dimensions of the first, outer housing 510, such that the second housing 511 is here pivotable about an angle of approximately 90°.

Inside the second cuboid housing 511, a camera 540 is mounted rotatably about a second rotation axis 530. The two rotation axes 520 and 530 are perpendicular to each other and preferably lie in the same plane. Thus, the optical axis of the camera 540 is tiltable in all directions but cannot be rotated about the optical axis. To be able to achieve the rotation about the optical axis, the image recording unit according to FIG. 2 can be mounted in a further housing about a third axis, which is at right angles to the two axes.

The camera 540 again comprises a rectangular frame 541 for gripping and for orienting the optical axis.

However, the dimensions and the shape of the housings 510 and 511 can also be made such that larger or smaller angles can be obtained. In particular, the housings 510 and 511 can be present as spherical shells, whereby any desired angles are obtainable.

The axes 520 and 530 can each be equipped with a hub motor, whereby an automatic orientation of the optical axis can be obtained.

FIG. 3 shows a schematic representation of the function of a gearwheel drive 200 for the automatic orientation of the optical axis, using the example of the camera 130. The drive 200 comprises a gearwheel 210, driven by a stepping motor (not shown). During a rotation of the gearwheel 210, the teeth come into contact with the surface of the ball-shaped, rotatably mounted camera 130, whereby a rotation of the camera 130 about an axis parallel to the axis of the gearwheel is achieved by static friction. In the phases in which the gearwheel 210 is not in contact with the camera 130, there is no rotation of the camera 130. The static friction between camera mount 121 (see FIG. 1) and camera 130 stabilizes the orientation of the camera 130 in such a situation. The notches or spaces between the teeth are provided in order to actively decouple the camera 130 from the gearwheel. In this arrangement, namely, a further stepping motor can be rotated which has another axis, for example an axis perpendicular to the present axis, together with an analogous gearwheel, so as to rotate the camera 130 about the last-mentioned axis. Finally, all of the possible movements about the midpoint of the ball bearing of the camera 130 can be achieved through the paired rectangular arrangement, or the paired non-parallel arrangement, of three such gearwheel drives 200. It may however also be enough to have two such gearwheel drives 200, of which the rotation axes are each oriented at right angles to the optical axis. In this case, only the rotation about the optical axis would be omitted. With the drive uncoupled, the camera 130 can also be oriented manually. Depending on the properties of the motors, a manual orientation may also be possible when the drive is coupled, the advantage of which is that the motors are able to stabilize the manual setting by means of friction.

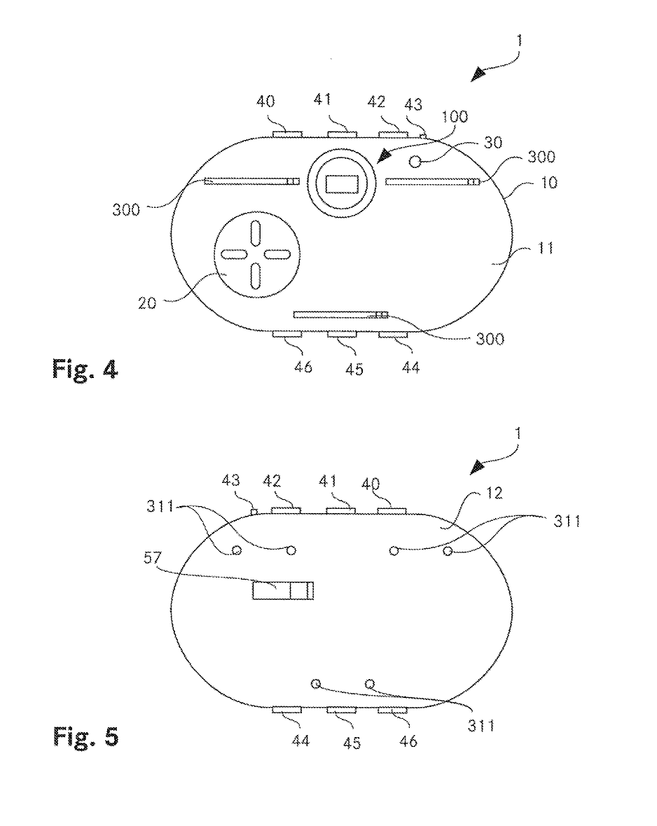

FIG. 4 shows a front view of an embodiment of the device 1 comprising an image recording unit 100 and a fastening device 40 for fastening to a garment. The device comprises a housing 10, which in the present case has substantially a cuboid shape with rounded edges. The image recording unit 100 and a knob 20 are let into the front face 11. The image recording unit 100 corresponds to that of FIG. 1. The knob 20 serves for setting the recording phases. A microphone is located behind an opening 30 of the front face 11. In the upper area of the housing 10, two fastening devices 300 are arranged next to each other in the front face, and, in the lower area, another one is arranged centrally with respect to the housing, which fastening devices will be explained in more detail with reference to FIG. 5.

On the top side of the housing 10 there are various buttons, namely a button 40 as record button “Rec”, a pause button 41, a stop button 42, and also a red and a green LED 43, the green lighting during operation and the red lighting during recording.

On the bottom side of the housing there are a memory card slot 44, a socket for a data cable 45, and a charging socket 46. A pull-out plug for attachment to a smart phone can also be provided.

FIG. 5 shows a rear view of the device 1 according to FIG. 4. On the rear 12 of the device 1 there is an ON/OFF switch for switching the device 1 on and off. Two pairs of openings 311 are introduced in the upper edge area, and one further pair of openings in the lower edge area, which serve as inlet and outlet openings 311, respectively, for the fastening device 300.

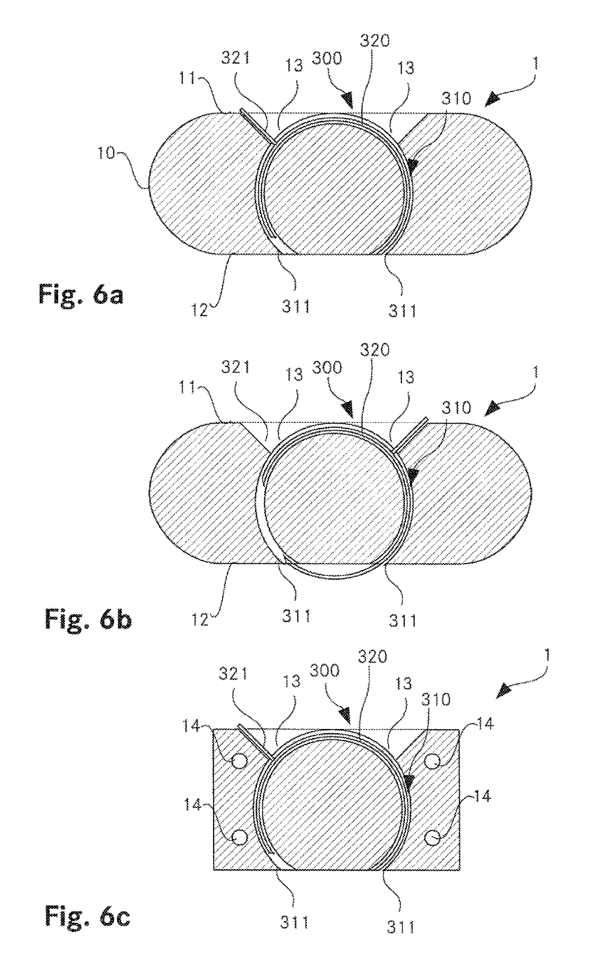

FIG. 6a shows a sectional representation, along the optical axis, through the fastening device 300 located in the open state. The fastening device 300 comprises substantially an interrupted circular channel 310, the axis of the circle being oriented at right angles to the optical axis. The interruption of the circular channel is located on the fear face 12 of the housing and is designed as two inlet/outlet openings 311 respectively. Inside the circular channel 310 there is an arc needle 320, which is movable in the circular channel 310 about the midpoint of the circle and which occupies approximately three quarters of the total circle. In the front face 11, the housing has two recesses 13 which adjoin the channel 310 in the outer area and serve to receive the actuation element 321, in the open position according to FIG. 6a and in the closed position according to FIG. 6b (see below). In the present case, the arc needle 320 has a larger cross section than the actuation element 321, such that the recesses 13 are designed substantially as slits which have a smaller width then the circular channel 310. Depending on the dimensioning of the channel, it is also possible to do without such recesses 13. Moreover, the fastening device 300 comprises an arc needle 320 which is guided in the channel 310. The needle 320 is dimensioned in such a way that, in the open state, no end thereof protrudes from one of the openings 311, but, in the closed state, preferably a part of the tip of one end reaches from the first opening 311 into the second opening 311, whereby the fastening device 300 gains stability in the closed position.

In order to close the fastening device 300 from the open position according to FIG. 6a, it is gripped via the actuation element 321, which is connected to the needle 320, and it is moved along the circular path from the first recess 13 to the second recess 13 (clockwise in the present case). A garment (not shown) lying in the area of the outlet openings 311 is at the same time pierced by the needle tip of the needle 320, such that the device 1 is fastened to this garment. FIG. 6b shows the fastening device in this state.

FIG. 6c shows a sectional representation through a further fastening device 300 located in the open state and designed as an exchangeable unit. The fastening device 300 in this case comprises four assembly bores 14 via which the fastening device 300 can be fastened releasably to a camera or else other objects such as name badges or the like. By way of the assembly bores 14, the fastening device 300 can be screwed, for example, onto an object. However, it is clear to a person skilled in the art that another assembly device can also be provided in order to mount the fastening device 300, for example clip devices, latching elements, etc.

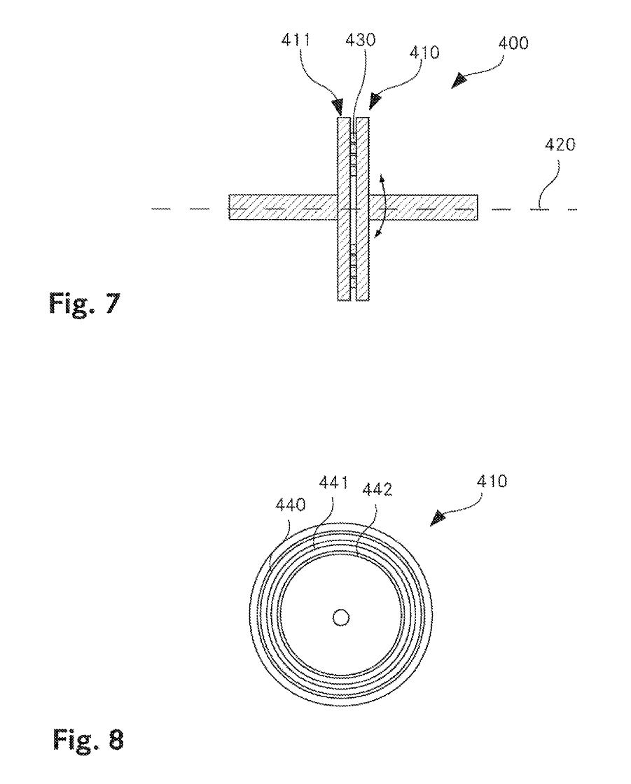

FIG. 7 shows a schematic sectional representation of a connector 400. The latter serves to record rotation movements about a line axis during the transmission of data, power or both. The core of this development lies in two disk-shaped connector plates 410, which are rotatable relative to each other about an axis 420. One of the plates has resilient contact elements 430 which, with low friction resistance, ensure the constant contact between the two plates 410, 411 for the transmission of data, power or both.

FIG. 8 shows a schematic representation of a connector plate 410 in the direction of the rotation axis 411. In particular, ring conductors 440-442 can be seen in FIG. 8 which are connected on the rear (not shown) to cables and transmit either data or power or both (power line data transmission) to the second plate.

In summary, according to the invention, a device with an image recording unit is made available which, while maintaining an optimal orientation of the optical axis, can be easily fastened to a garment and is additionally of simple construction.

1. A device for fastening to a garment, comprising a housing, an image recording unit having an optical axis and being connected to the housing, and a fastening device for fastening the housing to the garment, the housing having a bearing surface for bearing on the garment, characterized in that the optical axis of the image recording unit is tiltable or permanently tilted with respect to the perpendicular to the bearing surface.

2. The device as claimed in claim 1, characterized in that the image recording unit is tiltable about at least one rotation axis.

3. The device as claimed in claim 2, characterized in that the image recording unit is mounted in or on the housing via a ball guide, such that the image recording unit is tiltable along a spherical cap.

4. The device as claimed in claim 3, characterized in that the image recording unit comprises a protruding, on which an orientation of the image recording unit can be set and adjusted by hand.

5. The device as claimed in claim 3, characterized in that the ball guide can be actuated by means of a motor drive.

6. The device as claimed in claim 1, characterized in that it comprises a gravitation sensor, wherein the motor drive is in data communication with the gravitation sensor.

7. The device as claimed in claim 1, characterized in that the fastening device comprises a foldable part which is designed as a clamp when oriented parallel to the bearing surface and which is designed as a stand when pivoted with respect to the bearing surface.

8. The device as claimed in claim 1, characterized in that the fastening device comprises at least one needle and can be connected to the housing.

9. The device as claimed in claim 8, characterized in that the needle is designed as an arc-shaped needle which is guided in an arc-shaped guide, wherein the arc-shaped guide comprises at least one outlet opening in the bearing surface or in a surface adjoining the bearing surface.

10. The device as claimed in claim 9, characterized in that the needle is connected to an actuation element, wherein the guide comprises a slit for the passage of the actuation element.

11. The device as claimed in claim 9, characterized in that the arc-shaped guide is oriented at right angles to the bearing surface.

12. The device as claimed in claim 1, characterized in that it comprises a microphone.

13. The device as claimed in claim 1, characterized in that it comprises at least one operating element, or a status display, or both.

14. The device as claimed in claim 1, characterized in that it comprises a data processor which is connected to the image recording unit via a connector, wherein the connector has first and second contact faces which are oriented parallel to each other and are in sliding contact, wherein at least one of the contact faces is movable with respect to the second contact face in the plane of the contact face.

15. The device as claimed in claim 14, characterized in that the first contact face is rotatable with respect to the second contact face about a rotation axis, and wherein one of the contact faces has a ring conductor which is coaxial to the rotation axis and which is directed toward the other contact face and is in sliding contact.

16. The device as claimed in claim 2, characterized in that the rotation axis is oriented parallel to the bearing surface.

17. The device as claimed in claim 4, characterized in that the protruding is a rectangular frame.

18. The device as claimed in claim 5, characterized in that the ball guide can be actuated by means of a gearwheel drive.

19. The device as claimed in claim 8, characterized in that the fastening device comprises at least three needles.

20. The device as claimed in claim 8, characterized in that the fastening device can be connected to the housing in a releasable manner.

21. The device as claimed in claim 8, characterized in that the needle can be latched in order to lock it.

22. The device as claimed in claim 10, characterized in that the actuation element is oriented in a plane with a normal vector parallel to the tangent.

23. The device as claimed in claim 13, characterized in that the operating element is a knob.

24. The device as claimed in claim 13, characterized in that the status display is an LED.

25. The device as claimed in claim 15, characterized in that the first contact face and the second contact face is for data transmission and power supply.
